(19) United States
(12) Patent Application Publication
(10) Pub. No.: US 2024/0412394 A1
(43) Pub. Date: Dec. 12, 2024

(54) METHOD AND DEVICE FOR MEASURING DEPTH INFORMATION RELATING TO A SCENE ON THE BASIS OF STRUCTURED LIGHT GENERATED BY MEANS OF AT LEAST ONE PARALLEL RADIATION SOURCE

(71) Applicant: OQMENTED GMBH, Itzehoe (DE)

(72) Inventors: Berkan ZORLUBAS, Hamburg (DE); Peter BLICHARSKI, Essen (DE); Nicolai KLEMKE, Hamburg (DE); Ulrich HOFMANN, Itzehoe (DE); Thomas VON WANTOCH, Kiel (DE)

(21) Appl. No.: 18/692,552

(22) PCT Filed: Sep. 16, 2022
(86) PCT No.: PCT/EP2022/075763

§ 371 Date: Mar. 15, 2024

(30) Foreign Application Priority Data
Sep. 17, 2021 (DE) 10 2021 124 134.0

(51) Int. Cl. G06T 7/521; G02B 26/08

(52) U.S. Cl. CPC G06T 7/521; G02B 26/0833; G06T 2207/20084

(57) ABSTRACT

Methods and device for measuring depth information relating to a scene on the basis of structured light generated by means of at least one parallel radiation source, wherein the method comprises: generating a respective electromagnetic beam by means of at least one parallel radiation source; time-dependent sequential aligning or optically imaging the beam or at least one of the beams on different locations, in particular punctiform or line segment-shaped locations of a three-dimensional scene in order to irradiate the scene by means of the at least one imaged beam in the form of an irradiation pattern defined by the trajectory of the beam arising from the time-dependent alignment or imaging of the beam; detecting, at least in portions, an image representation of the irradiation pattern generated by an at least partial reflection of the irradiation pattern at one or more surfaces of at least one object present in the scene (namely, a physical object), and generating image information representing the detected image representation of the irradiation pattern; and evaluating the image information in order to calculate depth information in relation to the scene on its basis.

The present invention lies in the field of methods and devices for measuring depth information of a scene by using structured light. In particular, it relates to a method and devices for measuring depth information of a scene by means of structured light generated by at least one parallel radiation source, although the term “light” here is not necessarily limited to the visible spectral range of light (to the human eye) within the electromagnetic spectrum.

Common structured light methods, such as so-called “strip projection” (sometimes called “stripe light scanning” or “stripe light topometry”), use a predefined pattern (consisting of dots or stripes), projected onto a (physical) 3D object or a scene with several 3D objects. In order to determine the depth information, the distortions of the projected pattern generated by the height profile of the object or objects are detected from recordings of one or more cameras. Using the information about the distortion and the known position of the camera(s) and the projector, a distance of the respective object or points or portions of its surface from the projector can be determined as depth information by triangulation.

With this approach, the lateral resolution and, in the case of digital images, the pixel density are limited by the projected pattern. The finer the dots or stripes of the pattern are and the closer they are to one another, the more information or image points or pixels can be determined. In order to get more information about the scene or the respective object with a known pattern, the projected pattern must illuminate new aspects of the object, which can only be achieved by moving the camera structure or the object. Without moving the scenery or the camera setup, the information content of the recordings remains constant.

It is an object of the invention to create an improved system for measuring depth information of a three-dimensional scene, particularly with regard to the achievable spatial resolution and/or depth resolution of the measurement results.

This object is achieved according to the teaching of the independent claims. Various embodiments and developments of the solution are the subject matter of the dependent claims.

A first aspect of the solution relates to a method for measuring depth information relating to a scene on the basis of structured light generated by means of at least one parallel radiation source, wherein the method comprises: (i) generating a respective electromagnetic beam by means of at least one parallel radiation source; (ii) time-dependent sequential aligning or optically imaging the beam or at least one of the beams on different locations, in particular punctiform or line segment-shaped locations, of a three-dimensional scene in order to irradiate the scene by means of the at least one imaged beam in the form of an irradiation pattern defined by the trajectory of the beam arising by way of the time-dependent alignment or imaging of the beam; (iii) detecting, at least in portions, of an image representation of the irradiation pattern generated by an at least partial reflection of the irradiation pattern at one or more surfaces of at least one object present in the scene (namely, a physical object), and generating image information which represents the detected image representation of the irradiation pattern; and (iv) evaluating the image information in order to calculate therefrom depth information relating to the scene. The time-dependent sequential aligning or imaging of the beam or at least one of the beams onto different locations of the three-dimensional scene is carried out by deflecting the respective beam on at least one microscanner, with at least one respective MEMS mirror, in such a way that the time-dependent deflection of the MEMS mirror or mirrors at least partially defines the irradiation pattern.

The term “parallel radiation source”, as used here, means a source of radiation which provides a beam-shaped electromagnetic radiation, wherein the radiation—at least in vacuum or in air—has a minimum of divergence at least in relation to a direction perpendicular to its direction of propagation. The divergence can be in the range of 2 mrad (=2 mm/1 m) or less. The radiation can in particular be monochromatic and only lie in a specific narrow wavelength range of the electromagnetic spectrum. In particular, the term “parallel source” includes laser sources. The low-divergence electromagnetic radiation emitted by such a parallel radiation source is further referred to as an (electromagnetic) “beam”. Such a beam can in particular have a substantially punctiform or circular cross-section or a linear cross-section.

As possibly used herein, the terms “comprises,” “contains,” “includes,” “includes,” “has,” “with,” or any other variant thereof are intended to cover non-exclusive inclusion. For example, a method or a device that comprises or has a list of elements is not necessarily restricted to these elements, but may include other elements that are not expressly listed or that are inherent to such a method or such a device.

Furthermore, unless expressly stated to the contrary, “or” refers to an inclusive or and not to an exclusive “or”. For example, a condition A or B is met by one of the following conditions: A is true (or present) and B is false (or absent), A is false (or absent) and B is true (or present), and both A and B are true (or present).

The terms “a” or “an” as used herein, are defined in the meaning of “one or more”. The terms “another” and “a further” and any other variant thereof are to be understood to mean “at least one other”.

The term “plurality” as used herein is to be understood to mean “two or more”.

The term “configured” or “designed” to perform a specific function (and respective modifications thereof) is to be understood as meaning that the corresponding device is already provided in an embodiment or setup in which it can execute the function or is at least adjustable-in other words configurable-so that it can execute the function after corresponding setting. The configuration can take place, for example, via a corresponding setting of parameters of a process or of switches or the like for activating or deactivating functionalities or settings. In particular, the device can have multiple predetermined configurations or operating modes, so that the configuration can be carried out by selecting one of these configurations or operating modes.

The method according to the first aspect makes it possible to record a scene using at least one fixed radiation detector in order to detect the image representation of the irradiation pattern generated sequentially over a period of time and to generate the depth information on this basis. In particular, the irradiation pattern can be varied in time by aligning or imaging accordingly, so that an image representation of the irradiation pattern with high point or line density results in the observation period of the at least one radiation detector, which leads to an improved resolution of the extractable depth information in at least one direction, in particular in the depth direction (e.g. “Z direction”) or in one or more (lateral) directions (“X” or “Y” directions) perpendicular thereto. In particular, this makes it possible to continuously improve the level of detail of the recording and the resulting point cloud over the observation period without having to change the position of the radiation detector(s). The achievable resolution is then defined primarily or even exclusively by the ratio of the exposure or integration time of the respective radiation detector to the duration of the observation period.

In addition, because no pixels are projected but rather the trajectory itself is exploited, a non-modulated laser in particular can be used, which makes the electronics much simpler and cheaper. In addition, a much sharper and higher resolution projection can usually be achieved with a non-modulated laser than with artificially generated structured lighting with pixels.

The use of at least one microscanner for time-dependent sequential alignment or imaging of the beam or at least one of the beams at different locations in the three-dimensional scene allows, in particular, highly dynamic and very space-and weight-saving implementations. This is also particularly advantageous with regard to the use of Lissajous trajectories, since multidimensional, in particular two-axis, microscanners can be used for this.

Preferred exemplary embodiments of the method are described hereinafter, which in each case, unless expressly excluded or technically impossible, can be combined as desired with one another and with other aspects of the present solution, which will be described in the following.

In some embodiments, the time-dependent, sequential aligning or imaging of the electromagnetic beam or of the at least one of the beams takes place in such a way that the trajectory of the respective beam during the generation of the irradiation pattern corresponds at least in portions to a Lissajous figure. Lissajous scanning, in particular with-at least essentially-non-reproducing trajectories of the deflected beam, scans the surfaces in greater detail the longer the duration of the projection, namely the longer the trajectory. In particular, with a sufficiently long exposure or projection time when using at least essentially non-reproducing trajectories, in contrast to conventional MEMS-based laser projectors or Lissajous projectors with reproducing trajectories, there are no unreached gaps. In the case of a Lissajous projection with non-reproducing trajectories, the ratios of exposure duration to projection duration and/or measurement duration determine in particular, usually or even prevalently or mainly the achievable level of detail (resolution).

In some embodiments, the time-dependent, sequential aligning or imaging of the electromagnetic beam or of the at least one of the beams takes place in such a way that the trajectory of the respective beam during the generation of the irradiation pattern corresponds at least in portions to a spiral figure. In this way, a particularly uniform and timely coverage of the region covered by the spiral figure can be achieved, since the beam does not have to meanwhile scan other regions of the scene to be illuminated (namely while passing over the spiral figure).

In some embodiments, the beam or at least one of the beams has at least one spectral component with a wavelength of 490 nm or shorter and/or at least one spectral component with a wavelength of 700 nm or longer. This can be used to detect only or predominantly this at least one spectral component when detecting the image representation of the irradiation pattern and/or to evaluate the image information to calculate the depth information regarding the scene. All visible light information of the scene can thus be removed, simplifying detection and processing. In particular, by using a suitable optical bandpass filter or a camera (such as an IR camera) adapted to a non-visible spectral range including the at least one spectral component, the wavelength or the wavelength range of the projection system (namely the at least one spectral component) can be selectively detected on the image detected by the camera. In particular, if a very high resolution is desired, it can be advantageous to choose the wavelength or the wavelength range in the short-wave range, for example in the blue range of the visible spectrum or even in the ultraviolet range, since beams, in particular laser beams, can usually be generated and used with a particularly small beam diameter and detectors with particularly high sensitivity are also available.

Accordingly, in some embodiments, the beam or at least one of the beams is passed through a filter device for attenuating or filtering out electromagnetic radiation in a spectral range which is different from a wavelength or a wavelength spectrum of the beam, at least at one point along its path between the parallel radiation source and at least one radiation detector used to detect the image representation of the irradiation pattern. In this way, wavelengths or wavelength ranges (or equivalently: spectral ranges) can be filtered out that are not required for the detection of the image of the irradiation pattern with regard to the evaluation based thereon to determine the depth information, or which may even have a disruptive effect.

In particular, the filter device can be selected so that its filter is a band filter. This means that one or more bilaterally bounded spectral ranges or wavelength ranges can be specifically used for detection and potentially disturbing wavelengths beyond these bounds can be attenuated or even filtered out completely.

In some embodiments, in order to generate the irradiation pattern, the beam or at least one of the beams is guided through one or more optical elements of a diffractive or refractive type, by means of which the respective beam is spread. In this way, the original beam originally supplied by the parallel radiation source, for example a laser, can be adapted with reference to the application in terms of its cross section, in particular its diameter and/or shape.

In some embodiments, the time-dependent sequential alignment or imaging of the beam or at least one of the beams onto different locations of the three-dimensional scene takes place in a non-periodic manner, so that the trajectory of the respective beam is non-periodic at least over periods of time. In particular, moving trajectories can be generated in which the irradiation pattern they generate essentially completely covers the scene already after a short trajectory period, thus without the systematic occurrence of irradiation gaps. This means that in particular the time required for complete scanning and thus complete detection of depth information regarding the scene can be shortened.

In some embodiments, the beam or at least one of the beams is aligned or imaged at different locations in the three-dimensional scene in such a way that the irradiation pattern results in such a way that the trajectory of the beam or at least one beam does not repeat in a time interval that corresponds at least to one integration time of a radiation detector used to detect the image representation of the irradiation pattern. This means that irradiation gaps and double scanning of longer trajectory portions can be largely avoided and a particularly efficient scanning of the entire scene can be made possible.

In some embodiments, the parallel radiation source or at least one of the parallel radiation sources has comprises a laser or a light-emitting diode-based radiation source with a collimator as radiation source. In particular, the use of a light-emitting diode-based radiation source with a collimator enables a particularly low-energy solution, especially with regard to use in mobile, battery-or photovoltaic-powered devices or applications.

In some embodiments, the method further comprises: generating a position signal which represents, as a function of time, information which characterizes an orientation or imaging direction of the beam or at least one of the beams or a respective orientation or imaging direction present at the respective point in time. The position signal can in particular be used to determine a reference pattern from its time variation, which corresponds to an image representation of an undisturbed irradiation pattern, as would result on a flat, continuous reflection surface lying orthogonally to an optical axis of the projection of the respective beam. This reference pattern can be compared with the image information or the image representation of the reflected irradiation pattern represented by it in order to calculate the depth information regarding the scene based on the comparison as part of the evaluation of the image information.

In particular, when using a MEMS mirror to generate the irradiation pattern, the position signal can be generated as a time-dependent signal depending on the current mirror deflection of the MEMS mirror or at least one of the MEMS mirrors of the microscanner, in particular with regard to several different, in particular orthogonal, mirror axes of the microscanner. For this purpose, the microscanner itself can be provided with a corresponding position or deflection measuring device, for example based on one or more piezo-element sensors.

In some embodiments, as already mentioned above, a reference image is calculated on the basis of the position signal, which reference image corresponds to an undisturbed image of the irradiation pattern when it is reflected exclusively on a continuous, flat surface. Evaluating the image information comprises comparing the image of the scene represented by the image information with the reference image.

In some of these embodiments, the beam or at least one of the beams is intensity-modulated in a time-dependent manner, in particular by correspondingly operating the respectively assigned parallel radiation source, in particular a point beam source, so that in interaction with the also time-dependent sequential alignment or imaging of the respective beam at different locations of the three-dimensional scene the image of the irradiation pattern results in such a way that it represents, at least in portions, a pattern made up of a plurality of individual points or non-contiguous line segments. In this way, the amount of information to be processed as part of the evaluation of the image information can be reduced and thus the effort and energy consumption required for obtaining the depth information can be reduced, while the depth information can still be determined to a sufficient extent in many applications.

The comparison of the image representation of the scene represented by the image information with the reference image can be performed in particular using a triangulation calculation based on pairs of mutually corresponding points in the image representation of the scene represented by the image information on the one hand and the reference image on the other hand, as well as from known respective position and orientation of at least one radiation detector, in particular image sensor, used to detect the image representation. In particular, the possibility of being able to base the evaluation on (one-dimensional) point pairs instead of (multi-dimensional) lines or line segments facilitates the necessary calculations. This can be used in particular to increase speed and/or efficiency.

In particular, according to some of these embodiments, a respective position of at least one of the pairs of respective points corresponding to one another can be determined based on (i) a respective time stamp, which indicates a point in time along the course of a corresponding trajectory of the beam or at least one of the beams during generation of the respective image representation or reference image, respectively, or (ii) the use of at least one feature-based matching algorithm (in particular an image comparison algorithm for recognizing the same or similar images or image portions) to the respective representations of the trajectories of the respective beam in the image representation or the reference image.

In some embodiments: (i) at least one event-based camera (or equivalently: neuromorphic camera) is used for detecting the image of the irradiation pattern, in order to detect in an event-controlled (in particular exclusive) manner one or more image points in the image of the irradiation pattern, the image values of which have changed since the last previous recording; (ii) the operation of the event-based camera with time-dependent sequential aligning or imaging of the beam or at least one of the beams on respective different points of the three-dimensional scene is synchronized in time based on synchronization data; (iii) depending on the position signal and the synchronization data, the respective position of an image point corresponding to the respective detected image point in the reference image is calculated for the detected image point; and (iv) the comparison of the image representation of the scene represented by the image information with the reference image is performed using triangulation calculations based on the respective positions of each pair of detected image point and corresponding image point in the reference image.

A key advantage of this method is the opportunity it offers to reduce the amount of data processing required. The data processing here only has to relate to those image points (pixels) or image regions for which an event updating took place, i.e. at least one image point value (e.g. pixel color) has changed at all or beyond a predetermined threshold. On the other hand, if no event has been detected for a certain period of time, it means that there is no object in the measurable area within the field of view. This distinction is particularly advantageous for applications in which only a few or no objects are expected in the area of operation (e.g. drones). As long as no event occurs, image processing can be or remain suspended, thereby saving energy.

In contrast, in some other embodiments, which are based on the evaluation of entire images (e.g. image frames), it may be necessary to process the entire image with corresponding effort if in a scene with only one or a few objects few image points or pixels have usable information.

In some embodiments, at least one image sensor for capturing 2D images, in particular in the form of pixel grids, is used to detect the image representation of the irradiation pattern and to generate the corresponding image information. In addition, evaluating the image information comprises (additionally) evaluating the disturbances caused by the presence of the object(s) in the scene in the image representation of the irradiation pattern represented by the image information, in particular compared to the shape of the undisturbed irradiation pattern, in order to calculate therefrom depth information regarding the scene. Thus, the accuracy of the determined depth information can be increased, because by segmentation regarding the object or objects in the scene, for example, a rapid detection of noise and so-called “outliers” (i.e. image points that lie outside the expected object/segment) is possible.

The term “segmentation” means, as is customary in the field of image processing, the generation of regions which are related content-wise by aggregating adjacent pixels according to a specific homogeneity criterion. Segmentation with respect to an object is therefore to be understood as creating or identifying a region in the image, the pixels of which are to be assigned to the object.

In some embodiments, the image information is evaluated using a trained artificial neural network. The artificial neural network is or will be trained in particular on the basis of training data, which contain image representations of irradiation patterns represented by image information, which are in particular generated by the same image sensor or an image sensor of the same type, as well as correct depth information respectively assigned thereto. In addition, the image information and/or the depth information contained in the training data may have been or are determined at least in part using recordings of real scenes using a 3D image sensor, in particular using a time-of-flight, TOF, camera or using computer-aided simulations of such recordings. The use of a trained artificial neural network for image evaluation can be characterized in particular by a high degree of flexibility with regard to a wide variety of irradiation patterns to be analyzed and reliability with regard to the correct recognition of objects or the determination of the associated depth information.

In some embodiments, the image information and/or the depth information contained in the training data was or is additionally at least partially determined using recordings of real scenes using a 2D image sensor operating in the visible wavelength range, in particular using an RGB camera, or using computer-aided simulations of such recordings. In this way, the performance of the trained artificial neural network can be further increased, especially with regard to its ability to discriminate fine details in the image of the irradiation pattern compared to the reference image.

In some embodiments, at least one radiation detector is used to detect the image representation of the irradiation pattern, the integration time of which detector can be variably adjusted, wherein within the scope of the method this integration time of the radiation detector is set depending on a speed of aligning or deflection of the beam or at least one of the beams, in particular dynamically. In particular, an optimal coordination between the beam deflection and the integration time and, as a result, a high level of reliability with regard to a correct and efficient determination of the depth information can be achieved, because on the one hand, insufficient image scanning as well as overdetermined (multiple) image scanning can be avoided.

A further embodiment can consist in using not just one laser source, but rather laser sources of different wavelengths in order to take into account the possibly different reflectivities of different object surfaces/materials and thus achieve an improvement in the 3D measurement. Basically, different purposes of use also enable or are useful for completely different wavelengths.

To use such a 3D camera in a cell phone, for example, the phone will be equipped with just a single laser as cost-effectively as possible and the wavelength will be selected based on cost considerations (laser, electronics, detector, filter).

In the field of surveillance technology, however, it could be important to exploit the characteristic features of different materials in terms of reflectivity and therefore lead to a specific choice of wavelength or wavelengths (multiple lasers, filters and detectors). Even in case of 3D-detection of organic materials (e.g. food, fruit, vegetables, meat, etc.), detection with more than one laser wavelength may be suitable or even necessary.

In some embodiments, a Lissajous projector with a non-modulated laser is used in combination with at least one camera chip (such as a CCD chip) as radiation detectors. A key aspect and advantage of this combination is better operation of the camera when, with the help and support of, for example, a near-infrared laser, a lot of intensity is transmitted in a certain spatial direction and as a result the camera receives very good local illumination conditions. In a sense, this arrangement can also be understood as a (photo) flash, but not to brighten the entire scene, but to brighten a partial area. The composition of many locally illuminated scenes into an entirely illuminated and captured scene can have very special advantages in itself, namely that, for example, motion blur can be avoided by using very short-lived high local laser illumination intensity. Distributing the laser intensity with a scanner and implementing a kind of laser flash at certain points makes it possible to gradually image all regions sharply and without movement artifacts through scanning. This can be of considerable importance for use in vehicles if the environment is to be imaged without movement artifacts despite high speeds.

Based on this improved lighting, precise capture of 3D information through structured lighting is particularly possible. Structured lighting and evaluation of camera information can also be achieved through triangulation for 3D measurement in cars and other vehicles that otherwise usually use other techniques such as time-of-flight methods (LIDAR).

In the case of a Lissajous projection with non-reproducing trajectories, the ratios of exposure duration to projection duration and/or measurement duration mainly determine the achievable level of detail (resolution).

A further embodiment relates to the use of two fast axes in a bidirectional microscanner with a MEMS mirror, which means that a particularly large number of interlace images can be captured per unit of time, which can be advantageous for the above-mentioned aspects of avoiding movement artifacts.

A further embodiment relates to the targeted tuning of phase position and frequency of at least one of the two oscillation axes or resonant mirror oscillations of the microscanner, with the aim of tuning the feed rate at which the trajectory changes. A variable feed rate would also result in different line densities per unit of time and could make sense in an adaptive manner depending on the situation.

At the same time, it can be useful to design the field of view adaptively and variably in order to locally generate a higher or lower information density per unit of time depending on regions that have already been detected and evaluated in 2D or 3D.

In general, it can be that a camera initially captures an observed scene in a very general way. At the same time, with conventional cameras, all pixels for all wavelengths and all detected solid angles are recorded. With the help of the laser projector (and applied filters) important discrimination can be done. In particular, discrimination can take place according to solid angle, according to wavelength, according to time and, in principle, also according to pixel.

The solution presented here can therefore be understood much more broadly than just from the perspective of the 3D camera as a possible application.

Special further developments could comprise the use of multiple laser sources, projectors and cameras at different solid angles in order to be able to better detect different distances, for example.

A second aspect of the solution relates to a device for measuring depth information of a scene based on structured light generated by at least one parallel radiation source, wherein the device comprises:
(i) at least one parallel radiation source for generating a respective electromagnetic beam;
(ii) at least one microscanner for time-dependent sequential alignment or optical imaging of the beam or at least one of the beams at different, in particular punctiform or line segment-shaped, locations of a three-dimensional scene in order to irradiate the scene using the at least one imaged beam in the form of an irradiation pattern resulting from the time-dependent alignment or imaging of the beam or beams defined by one or more trajectories of the beam or beams;
(iii) a radiation detector for detecting at least in portions an image representation of the irradiation pattern generated by at least partial reflection of the irradiation pattern on one or more object surfaces in the scene, and for generating image information that represents the detected image representation of the irradiation pattern; and
(iv) an evaluation device for evaluating the image information in order to calculate depth information regarding the scene.

In some embodiments, the device is configured or has means suitable for carrying out the method according to the first aspect, in particular according to one of the embodiments thereof described herein.

A third aspect of the solution relates to an electronic device, in particular a computer, consumer electronics device, communication terminal (e.g. smartphone, AR/VR glasses, television, monitor, or portable computer, such as tablet PCs) and/or medical devices, having a, in particular therein integrated device according to the second aspect.

Further advantages, features, and possible applications of the present invention result from the following detailed description in conjunction with the figures.

In the figures:

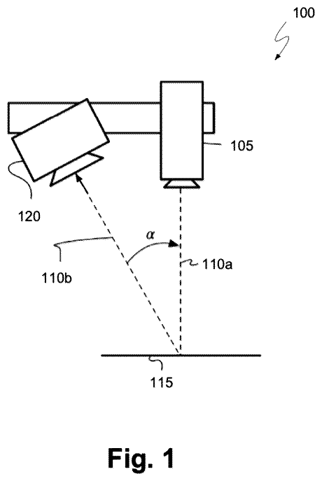

FIG. 1 schematically shows a basic principle of laser triangulation as it can be used in the present solution;

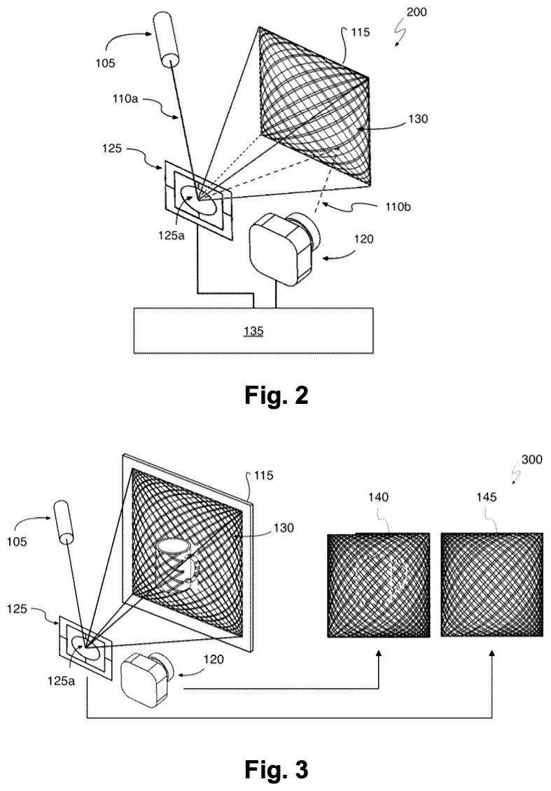

FIG. 2 schematically shows an exemplary embodiment of a device for carrying out a method for measuring depth information of a scene using a microscanner to image a laser beam onto the scene; and

FIG. 3 shows a further view of the device from FIG. 2, together with a reference image and an image captured by an image sensor of the trajectory of the laser beam reflected by the scene;

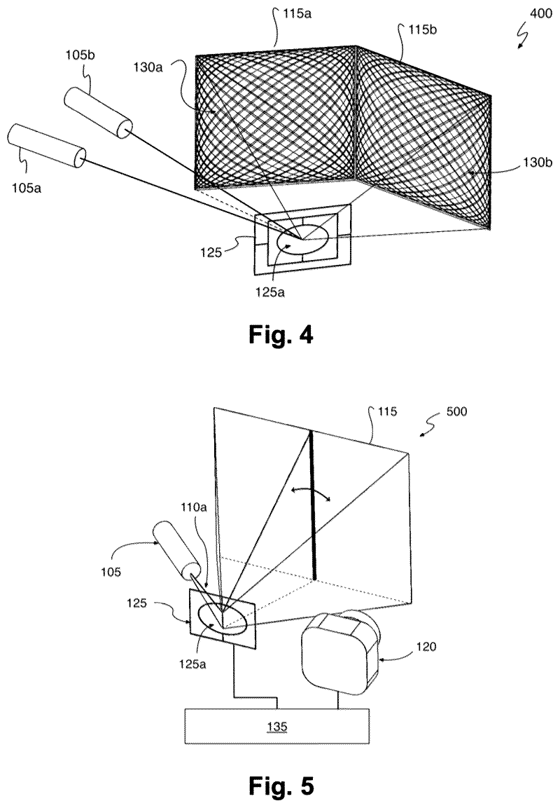

FIG. 4 shows a further exemplary embodiment of a device for carrying out a method for measuring depth information of a scene using a microscanner for imaging several differently directed laser beams onto a scene;

FIG. 5 shows a further exemplary embodiment of a device for carrying out a method for measuring depth information of a scene using a microscanner for imaging a laser beam with a line-shaped beam cross section onto a scene;

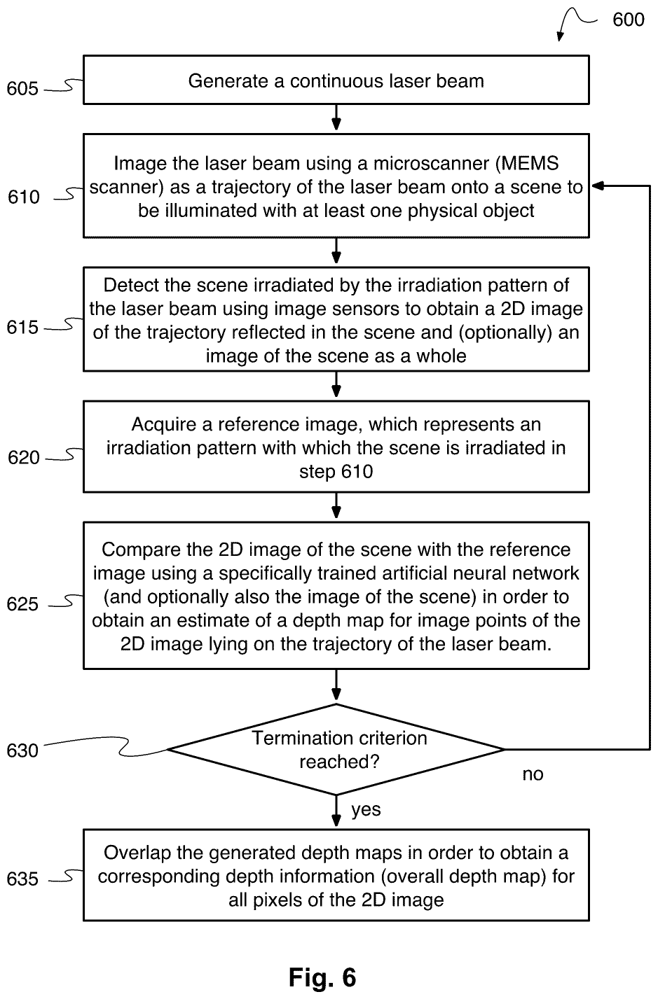

FIG. 6 shows a flowchart to illustrate a preferred embodiment of a method for measuring depth information of a scene, which can be carried out in particular by means of a device according to FIG. 2 or 3, 4 or 5;

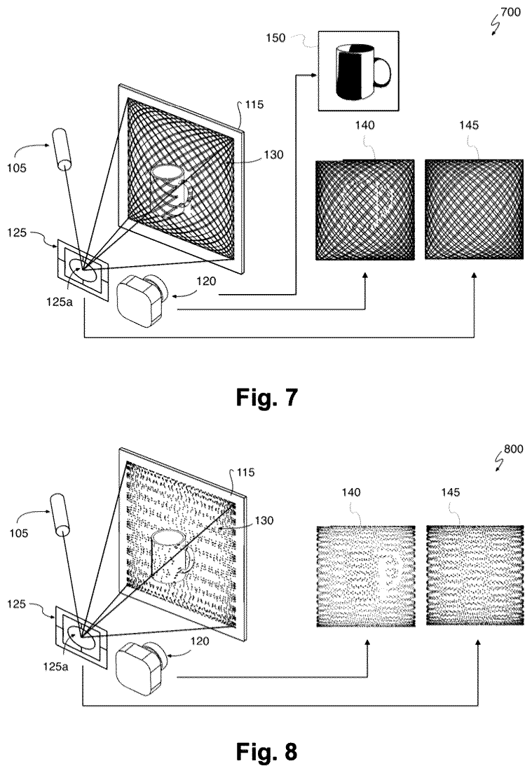

FIG. 7 shows a variant of the device from FIGS. 2 and 3, in which an image representation of the scene as a whole (namely not just the locations of the scene swept by the trajectory of the laser beam) is additionally captured by an image sensor and used to determine the depth information;

FIG. 8 shows another exemplary embodiment 800 of a device for carrying out a method for measuring depth information using an intensity-modulated beam to illuminate the scene;

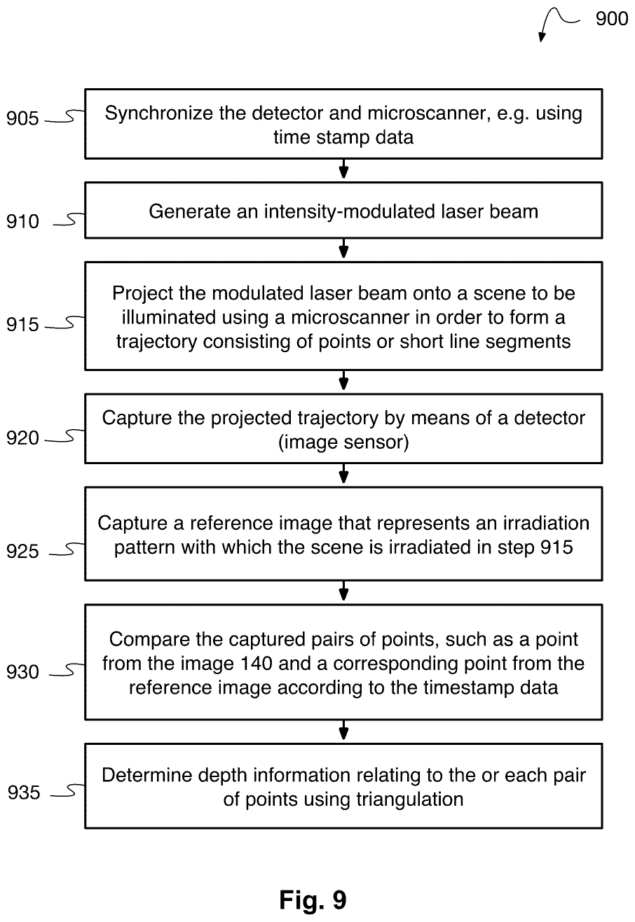

FIG. 9 shows an exemplary embodiment of a method for measuring depth information that can be carried out with the device from FIG. 8;

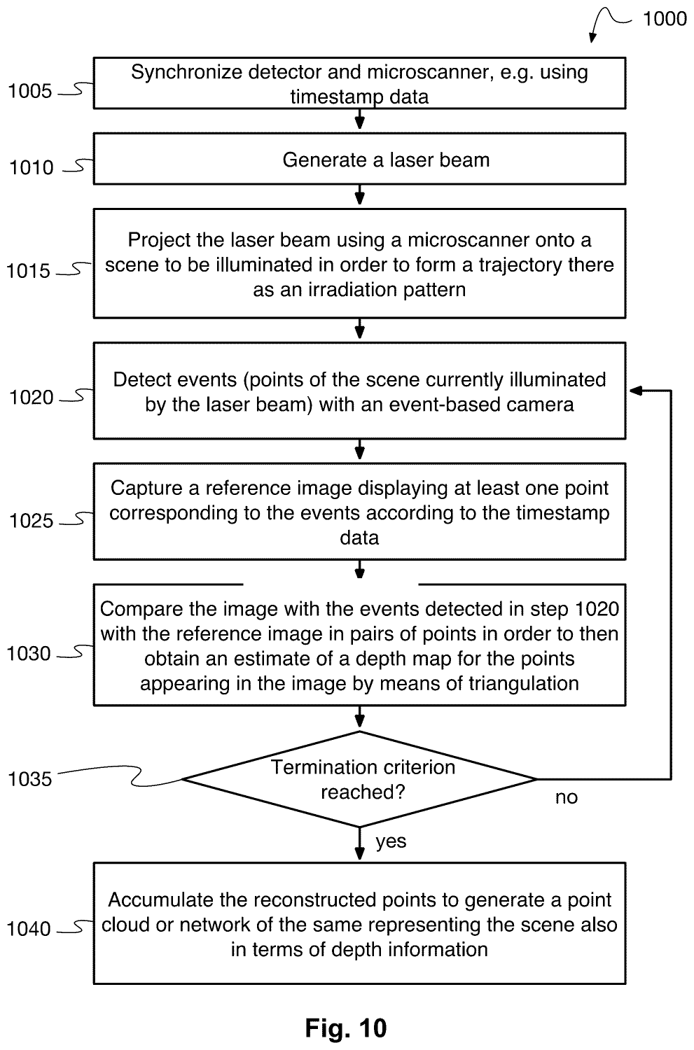

FIG. 10 shows a further exemplary embodiment of a method for measuring depth information; and

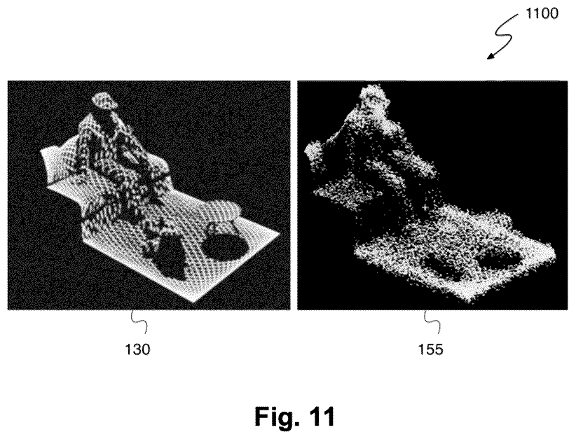

FIG. 11 shows an exemplary scene, on the one hand using an irradiation pattern projected onto the scene according to the method from FIG. 10 and on the other hand using a point cloud captured as an image (image representation of the irradiation pattern reflected from the scene) using a detector in the form of an event-based camera.

In the figures, the same reference numbers denote the same, similar or corresponding elements. Elements depicted in the figures are not necessarily represented to scale. Rather, the various elements shown in the figures are presented in such a way that their function and general purpose can be understood by those skilled in the art. Connections and couplings, shown in the figures, between functional units and elements can also be implemented as an indirect connection or coupling, unless expressly stated otherwise.

FIG. 1 illustrates a basic principle of laser triangulation 100, as can be used in the present solution. A laser 105 is used as a parallel radiation source in order to generate a laser beam 110a and direct it onto a scene to be scanned, which here, for example, only contains a flat surface as object 115. The laser beam 110a is at least partially reflected on the object 115 and the reflected radiation 110b, which can in particular be also beam-shaped if the surface of the object 115 at the point of impact of the laser beam 110a is sufficiently smooth and flat, is detected by an image sensor 120, in particular a digital camera. The angle a can be deduced from the position of the reflected radiation 110b in the captured image. From this, also together with the known positions of the laser 105 and the image sensor 120, the distance of the laser 105 from the reflection point of its laser beam 110a on the object 115 and thus corresponding depth information that indicates this distance can also be determined using triangulation.

In the embodiment 200 of a device for measuring depth information of a scene illustrated in FIG. 2, a laser beam 110a is not directed directly at the scene 115 to be examined, but instead indirectly via a mirror image representation using a microscanner. The laser beam 110a is guided over the scene by a movable, for example gimbaled, suspended mirror 125 of the microscanner 125 for scanning. In the example of FIG. 2 this takes place using a two-dimensional, essentially harmonic oscillation of the microscanner 125, which leads to a two-dimensional Lissajous figure as an irradiation pattern 130 and can be achieved by a suitable, in particular harmonic, control of a drive of the microscanner 125.

If there is at least one object in the scene that at least partially reflects the laser beam on its surface in order to provide a reflected beam 110b, the trace of the reflection point of the laser beam 110b forms on the surface (or in the case of several objects: on several object surfaces) a linear trajectory. The course of the trajectory is essentially due to the movement of the mirror 125a of the microscanner 125. In FIG. 2, the laser beam 110b is shown as an example for a point in time during which the irradiation pattern 130 is passing through.

The microscanner 125 can in particular be a two-axis microscanner, which enables the incident laser beam 110a to be deflected in two dimensions and thus to illuminate a solid angle, as illustrated in FIG. 2. In particular, by appropriately controlling a drive of the mirror movement of the microscanner, it can be achieved that the trajectory forms a Lissajous figure as an irradiation pattern 130 for the scene (see FIG. 2). This irradiation pattern can in turn be captured with an image sensor 120 as an image or image sequence (e.g. video) and transmitted as corresponding image information to an evaluation device 130 for evaluating the image information.

The device 200 also has an evaluation device 135 for evaluating the image information in order to calculate depth information regarding the scene. This will be further explained below with reference to FIG. 3.

FIG. 3 shows in a further view 300 the device 200 of FIG. 2, this time however in connection with a scene 115, in which a three-dimensional object, such as in this case a cup is present in front of a reflecting plane (such as a screen, or a wall, etc.). The image sensor 120 and the evaluation device 130 are also present, but are not shown in FIG. 2 to simplify the illustration (the same applies to all other figures in which various embodiments of devices for measuring depth information of a scene are shown.

The plane and the cup reflect the radiation coming from the microscanner 125 at least partially in the direction of the image sensor 120, so that an image representation of the irradiation pattern reflected in this way can be captured by an image sensor as an image or image sequence. The view 300 additionally shows such an exemplary image 140 of the scene recorded on the image sensor 120 as well as a reference image 145, which represents the irradiation pattern directed onto the scene 115 by the microscanner (namely before reflection on one or more object surfaces of the scene, here on the plane or the cup).

The reference image 145 can be determined in particular by measuring the position of the mirror 125 and thus the associated deflection angle for each oscillation axis from a rest position of the mirror and from this the angle at which the reflected beam is reflected in the direction of the scene at the respective time, is calculated. Measuring the deflection angles can be carried out in particular on the microscanner itself, for example by piezo sensors which are attached on a suspension of the mirror 125 and configured, based on a force acting on them when the mirror is deflected and measured piezoelectrically, to provide a measurement signal corresponding to the deflection, in particular proportional thereto.

By means of the evaluation unit 135, a data processing device, depth information regarding the object surface(s) in the scene 115 can now be calculated based on a comparison of the image information or the recorded image 140 of the scene represented by it with the reference image 145, in particular using laser triangulation. In the present example, due to the three-dimensional shape of the cup, the surface of the cup has a spatially variable distance (depth) from the microscanner, so that the locations at which the irradiation pattern coming from the microscanner 125 are reflected locally on the cup surface are also at different distances from the microscanner 125 and not on a plane. This results in distortions in the image representation 140 compared to the undisturbed irradiation pattern 145. The distortions are determined in connection with the comparison and form the basis for determining the depth information representing the depth profile of the reflecting surfaces of the scene 115.

FIG. 4 shows a further embodiment 400 of a device for measuring depth information of a scene. It differs from the embodiment 200 from FIGS. 2 and 3 in that not just a single laser beam, but a plurality of differently directed laser beams are imaged using the microscanner 125. In the present example, two lasers 105a and 105b are shown, which radiate from different directions onto the mirror 125 of the microscanner 125 in order to generate two different irradiation patterns 130a and 130b through a respective mirror representation and thus illuminate two different scenes or two different regions of a scene. These regions can be disjoint or at least partially overlapping and in particular also contain different physical objects 115a, 115b.

Instead of a single image sensor 120, it is also possible, in particular, to provide a separate image sensor for each laser or irradiation pattern, which is directed to the respectively assigned irradiation pattern 130a or 130b in order to detect this in the best possible way using an image sensor.

Furthermore, the device 400 can correspond in particular to the device 200.

FIG. 5 shows a further embodiment 500 of a device for measuring depth information of a scene. Here, instead of a point laser, i.e. a laser with a substantially punctiform beam cross section of small diameter, a radiation source 105 with a linear beam cross section is used.

To generate the linear, in particular rectilinear, beam cross-section, corresponding optics can, for example, be placed in front of a laser 105 with a punctiform beam cross-section, which spreads the laser beam 110a supplied by the laser into a line. The resulting laser beam 110b with a linear cross section can then be used to illuminate a scene 115, in particular to scan it regularly. For this purpose, in particular a microscanner 125 with a mirror 125a can be used, which here can also be designed specifically as a (only) single-axis microscanner 125, which deflects the laser beam 110b along a spatial dimension (scanning direction) lying transversely to its direction of extension (horizontal in FIG. 4), since a second dimension of the scanning is already given by the (vertical in FIG. 4) extension of the linear laser beam cross section.

Furthermore, the device 500 can correspond in particular to the device 200.

The exemplary embodiment of a method 600 for measuring depth information of a scene, illustrated in FIG. 6 can be carried out in particular by means of one of the devices according to FIG. 2 or 3, FIG. 4 or 5 and is therefore described in the following illustratively with additional reference to the device of FIGS. 2 and 3.

The method 600 is based on the use of a continuous electromagnetic beam, in particular a laser beam, to illuminate an observed scene 115 based on a trajectory of the beam guided across the scene 115. For this purpose, the continuous beam is generated (in step 605) and (in step 610) directed onto the scene by scanning imaging of the beam (laser beam) by means of a microscanner 125 to form a trajectory.

The scene 115 usefully contains at least one physical object that at least partially reflects the beam, so that (in step 615) an image representation of the irradiation pattern 130 created by reflection of the beam on the at least one object is detected using an image sensor, for example using a camera 120 (frame-based detector (image sensor)) as a 2D image representation 140. The irradiation pattern 130 indicates the trajectory of the beam formed from the locations of reflection of the beam on the object(s).

Optionally, an image representation of the scene 115 in its entirety (“overall image” 150), i.e. also the image portions (pixels) not yet swept by the trajectory, can be detected, especially by the same camera 120. The trajectory can then be extracted from the captured overall image 150 of the scene 115, for example, using filtering as part of image processing.

Furthermore, a reference image 145 is captured (in step 620), which represents an irradiation pattern (before its reflection) imaged onto the scene 115 by the microscanner 125. As already mentioned, it can be determined in particular on the basis of a sensory measurement of the deflections of the mirror 125a of the microscanner. Steps 605 to 620 occur simultaneously.

Now (in step 625) depending on the image representation 140 and the reference image 145 and optionally also on the overall image 150 of the scene 115 (cf. view 700 in FIG. 7), a depth map of the scene 115, more precisely of the locations of the scene swept by the trajectory or a subset thereof. This can be done in particular by using an adequately trained artificial neural network (such as by “Deep Learning”), to which the image 140, the reference image 145 and optionally also the overall image 150 of the scene are provided as input data, and which then provides the depth map as depth information regarding the scene 115, more precisely the above locations of the scene traversed by the trajectory.

Based on a predetermined termination criterion, a decision can now be made as to whether the steps 610 to 625 should be repeated (630—no) or not. The termination criterion can in particular be defined in such a way that it specifies a minimum moving time of the trajectory over the scene or a minimum degree of coverage of the scene to be achieved by the trajectory that has been traversed so far, which must have been achieved before the depth information is considered to be sufficiently complete and therefore a further repetition of process steps 610 to 625 is omitted.

If the termination criterion is reached (630—yes), then (in step 635, unless there was only a single execution of steps 610 to 625) depth information (in particular a depth map) of the scene 115 is generated as a method result in that the individual depth maps generated in the context of the method are combined into an overall depth map through combination, in particular overlap. In the case of only one execution, the depth map created also represents the overall depth map.

Another particular embodiment of the present solution will now be described with reference to FIGS. 8 and 9. FIG. 8 shows an associated further exemplary embodiment 800 of a device for executing a method for measuring depth information of a scene and FIG. 9 illustrates an embodiment 900 of the method itself that can be carried out with the device 800 from FIG. 8.

FIG. 8 substantially corresponds to FIG. 3, but differs from it in that no continuous trajectory is generated, but instead the trajectory is divided into individual points or short line segments, in that the beam used to irradiate the scene is intensity modulated accordingly. This has the particular advantage that the amount of image data to be processed as part of the comparison of the image 140 with the reference image 145, which is correspondingly modulated, can be significantly reduced without strongly reducing the quality of the available depth information.

In the method 900, in a step 905, the detector or image sensor 120 and the microscanner 125 are synchronized in such a way, in particular based on time stamps or time stamp data representing them, that for each of a set of successive times, the momentary deflection of the mirror 125a of the microscanner 125 and the associated detection by the image sensor 120 are recorded and can therefore be assigned to one another. In a further step 910, an intensity-modulated laser beam is generated and, in a step 915, directed onto the mirror 125a of the microscanner 125 in order to be projected as an irradiation pattern onto the scene 115, depending on the modulation, in order to create there a trajectory made up of points or short line portions. The trajectory is captured in step 920 by the detector or image sensor 120 as an image representation 140. In addition, in a step 925, as in the embodiment according to FIG. 2, a reference image 145 is captured, which represents the irradiation pattern with which the scene is irradiated in step 915. Steps 910 to 925 and optionally also step 905 take place simultaneously.

For evaluation, in step 930 the pairs of points are evaluated by comparison, each of which pair consists of a point of the image 140 and a point of the reference image that corresponds to it in time according to the timestamp data. From the deviations in the positions of the two points in one or more pairs of points that may be determined during the comparison, the desired depth information can be deduced in step 935 using triangulation.

Another particular embodiment of the present solution will now be described with reference to FIGS. 10 and 11. FIG. 10 shows an associated embodiment 1000 of a method for measuring depth information of a scene and FIG. 11 illustrates a corresponding exemplary scene 1100, on the one hand based on an irradiation pattern 130 projected onto the scene and on the other hand based on a point cloud obtained as depth information.

An event-based camera is an image sensor that reacts to local changes in brightness. Such cameras do not take images with a shutter, as is the case with conventional cameras (image cameras). Instead, each pixel in an event-based camera works independently and asynchronously, reporting brightness changes when they occur and remaining silent otherwise.

Therefore, when the beam 110b is projected onto the scene, only those pixels on which the beam falls at an observed point in time are captured, while other pixels are not detected.

In method 1000, the detector 120 and the microscanner are again, as already explained above, synchronized in step 1005 using time stamps in order to be able to combine temporally corresponding points from the detected image representation 140 and the reference image 145 into a respective pair of points. In addition, as usual, a laser beam 1010, in particular a continuous one, is generated (step 1010) and projected onto the scene (step 1015). The resulting irradiation pattern is illustrated in the left image of FIG. 11 for an exemplary scene 115.

If the laser beam falls on a surface of an object and is reflected there in such a way that the reflected beam is detected by the event-based camera via an associated change in intensity (step 1020), the currently illuminated point corresponds to an event detected by the event-based camera and can therefore be evaluated in the further course of the method. For this purpose, the reference image 145, more precisely the current position (deflection) of the mirror 125a of the microscanner, is first determined (step 1025). The entirety of these current positions forms the entire reference image 145.

In pairs of points, the position of the point detected in step 1020 in the image 140 can now be compared with the position of the temporally corresponding point of the reference image or step 1025 and, based on any deviation between the two points, the desired distance of the point can be determined using triangulation in the scene 115 as depth information (step 1030). Steps 1020 to 1030 are then repeated for other points along the trajectory (1035—no) until a predetermined termination criterion (e.g. the expiration of a predetermined period of time) is met (1035—yes). Finally (in step 1040) the points reconstructed in terms of their distance are cumulated into a point cloud 155 in order to form a depth map of the scene (an exemplary such point cloud 155 is illustrated in the right-hand image of FIG. 11). Alternatively, instead of a point cloud, a network (mesh) spanned by the points as nodes can be created as a depth map.

In summary, the embodiments explained in the description of the figures can be described again as follows:

In order to create lines as easily as possible that capture a 3D object in its entirety, a device can be used, with a microscanner 125 with a bi-resonant scanning MEMS mirror 125a with an integrated solution (an external solution is also possible) to determine the mirror position (deflection), a constantly illuminating punctiform or linear emitter 105 (an optional modulation of the emitter 105 increases the time until the 3D object is completely illuminated) and an image sensor (detector) 120. The beam 110a of the emitter 105 is deflected via the MEMS mirror and is used to illuminate a scene 115. For example, Lissajous figures are generated, the shape of which and thus the illumination of the scene 115, or of one or more objects therein, depends on the frequencies of both axes of the microscanner 125 or its mirror 125a.

The mirror position (deflection) assumed during the scanning process can be read out at any time and forwarded to a processing unit (evaluation device 135). In parallel, a spatially offset detector 120 records the scene and transfers the image information to the same processing unit 135, which also has access to the mirror position. By evaluating the image information 140, X, Y coordinates of the projected point/line are determined. The depth information is extracted from the overlay of the information of projection location (taken from the reference image) and the offset between the expected and actual X, Y location of the point/line on the image representation 140.

A distinction can be made between various other embodiments, which differ mainly in the way the detector (image sensor) works and the resulting processing of the information. Two of these embodiments are described in more detail below by way of example.

### 1. Frame-Based Camera as a Detector

In this case, as has already been explained in more detail with reference to FIGS. 2 to 6, the entire scene 115 is recorded over a certain period of time, for example by an IR camera 120 as a detector. This means that the trajectory, in particular the Lissajous trajectory, captures a contiguous strand that, depending on the time window, illuminates a large area of the scene (see image representation 140). In addition, the information is created for the entire field of view (FOV) of the detector and not just for the illuminated regions. By using a corresponding optical filter or an adapted IR camera, only the illuminated region is visible in the image recording. All color information, such as RGB information from the scene is thereby removed, thereby simplifying the detection of the trajectory on the recording (see image representation 140).

In addition to the illuminated recording, the reference trajectory (reference pattern 145) is determined based on the mirror positions that are assumed within the time period, which trajectory corresponds to a trajectory which results, for example, from the projection onto a surface at a distance of 1 m. The depth information is determined from the deviation between the recorded image 140 and the reference pattern 145 using complex calculation or extraction methods, such as a neural network (NN). The neural network supplies the missing depth information Z to the X, Z coordinates known from the recording. The determination of the reference trajectory in the reference image 145 based on the mirror position can be determined in particular previously (namely before the operational use of the neural network for determining the depth information Z) and already supplied to the neural network via the training data as part of its training. When recording images to determine the depth information, no information about the mirror position needs to be detected, but only the recorded image representation 140 needs to be analyzed via the neural network.

In order to obtain further information about the scene, the overall image (such as the RGB image) (which may be available via an additional camera) can be optionally sent to the neural network as input. This allows the accuracy of the depth information determined to be increased, since, for example, the segmentation (in the sense of image processing) of the objects in the scene makes it possible to quickly detect noise and outliers (i.e. points that lie outside the expected object/segment).

### 2. Event-Based Camera as a Detector

In this case, as already explained in more detail with reference to FIGS. 10 and 11, the step of evaluating the X, Y coordinates in the recording of the scene is greatly simplified due to the use of an event-based camera as a detector, since only the information or coordinates are sent in which a change was detected. In combination with an optical filter that is designed for the wavelength of the emitter, in particular a punctiform emitter (e.g. laser), the selective perception of the detector can be reduced to such an extent that only the point illuminated by the beam is visible in the recording and is therefore transmitted. Furthermore, filtering can reduce or avoid the potentially disruptive influence of other radiation sources and reduce the complexity of further processing.

Thus, by recording via an event-based detector, the continuous line of the trajectory, in particular the Lissajous trajectory, is divided into small processing units and forwarded for processing.

The recording of a single, projected point or very small, contiguous lines, which can be reduced again to a point using methods such as center of gravity determination, provides the depth information using the mirror position taken at this point in time via the triangulation method. This camera-side modulation and simultaneous reduction of the data stream (only the position is forwarded) ensures quick and easy processing.

The solutions presented here thus enable in particular an improved lateral resolution (and thereby indirectly also improved depth resolution) through the constantly changing structured light, more precisely, through the constantly changing trajectory, in particular Lissajous trajectory. In a static or slowly changing scene, the number of visible details is only determined by the exposure time, which in turn correlates with the scanning speed of the mirror. Nevertheless, when the scene changes quickly, the approach still provides enough information about the entire scene, so that the approach is superior to conventional systems in terms of lateral resolution, without compromising on responsiveness or frame rate.

### LIST OF REFERENCE NUMERALS

100 laser triangulation
105 parallel radiation source, such as a laser
105a, b parallel radiation source, such as a laser
110a laser beam (before reflection on the object)
110b laser beam reflected on the object
115 scene
115a, b different scenes or scene regions
120 image sensor
125 microscanner
125a (MEMS) mirror of the microscanner 125
130 irradiation pattern
130a, b irradiation pattern
135 evaluation device or processing unit
140 (2D) image of the scene
145 reference image
150 overall image of the scene
155 point cloud
200 first embodiment of a device for measuring depth information
300 further view of device 200
400 second embodiment of a device for measuring depth information
500 third embodiment of a device for measuring depth information
600 first embodiment of a method for measuring depth information
700 further view of device 200 according to a variant
800 fourth embodiment of a device for measuring depth information
900 second embodiment of a method for measuring depth information
1000 third embodiment of a method for measuring depth information
1100 exemplary scene

What is claimed is:

1. A method for measuring depth information relating to a scene on the basis of structured light generated by means of at least one parallel radiation source, wherein the method comprises:
generating a respective electromagnetic beam by means of at least one parallel radiation source:
time-dependent sequential aligning or optically imaging of the beam or at least one of the beams at different locations, in particular punctiform or line segment-shaped locations, of a three-dimensional scene in order to irradiate the scene by means of the at least one imaged beam in the form of an irradiation pattern defined by one or more trajectories of the beam of beams arising by way of the time-dependent alignment or imaging of the beam or beams:
detecting, at least in portions, of an image representation of the irradiation pattern, generated by an at least partial reflection of the irradiation pattern at one or more surfaces of at least one object present in the scene and generating image information which represents the detected image representation of the irradiation pattern; and
evaluating the image information in order to calculate therefrom depth information regarding the scene;
wherein the time-dependent sequential aligning or imaging of the beam or at least one of the beams onto different locations of the three-dimensional scene is carried out by deflecting the respective beam on at least one microscanner, with at least one respective MEMS mirror, in such a way that the time-dependent deflection of the MEMS mirror or mirrors at least partially defines the irradiation pattern.

2. (canceled)

3. (canceled)

4. The method according to claim 1, wherein the beam or at least one of the beams has at least one spectral component with a wavelength of 490 nm or shorter and/or at least one spectral component with a wavelength of 700 nm or longer.

5. The method according to claim 1, wherein the beam or at least one of the beams is passed through a filter device for attenuating or filtering out electromagnetic radiation in a spectral range which is different from a wavelength or a wavelength spectrum of the beam, at least at one point along its path between the parallel radiation source and at least one radiation detector used to detect the image representation of the irradiation pattern.

6. (canceled)

7. The method according to claim 1, wherein in order to generate the irradiation pattern, the beam or at least one of the beams is guided through one or more optical elements of a diffractive or refractive type by means of which the respective beam is spread out.

8. The method according to claim 1, wherein the time-dependent sequential aligning or imaging of the beam or at least one of the beams at different locations of the three-dimensional scene takes place in a non-periodic manner, so that the trajectory of the respective beam runs non-periodically at least for certain periods of time.

9. (canceled)

10. (canceled)

11. The method according to claim 1, further comprising:
generating a position signal which represents, as a function of time, information which characterizes an orientation or imaging direction of the beam or at least one of the beams or a respective orientation or imaging direction present at the respective point in time.

12. (canceled)

13. The method according to claim 11, wherein:
a reference image is calculated on the basis of the position signal, which reference image corresponds to an undisturbed image representation of the irradiation pattern when reflected exclusively on a continuous flat surface; and
the evaluating of the image information comprises comparing the image representation of the scene represented by the image information with the reference image.

14. The method according to claim 13, wherein the beam or at least one of the beams is intensity-modulated in a time-dependent manner, in particular by correspondingly operating the respectively assigned punctiform radiation source, so that, in interaction with the also time-dependent sequential aligning or imaging of the respective beam at different locations of the three-dimensional scene, the image representation of the irradiation pattern results in such a way that it represents, at least in portions, a pattern made up of a plurality of individual points or non-contiguous line segments.

15. The method according to claim 14, wherein the comparison of the image representation of the scene represented by the image information with the reference image takes place by using a triangulation calculation based on pairs of mutually corresponding points in the image representation of the scene represented by the image information, on the one hand, and the reference image, on the other hand, as well as of the position signal and the respective known position and orientation of at least one radiation detector, in particular image sensor, used to detect the image representation.

16. The method according to claim 15, wherein at least one of the pairs of points corresponding to one another is based on timestamps characterizing a point in time along the course of a corresponding trajectory of the beam or at least one of the beams when generating the respective image representation or reference image, respectively, or by applying at least one feature-based matching algorithm on the respective representations of the trajectories of the respective beam in the image representation or the reference image.

17. (canceled)

18. (canceled)

19. The method according to claim 1, wherein the image information is evaluated using a trained artificial neural network.

20. (canceled)

21. (canceled)

22. (canceled)

23. The method according to claim 1, wherein at least one radiation detector is used to detect the image representation of the irradiation pattern, the integration time of which detector can be variably adjusted, wherein, within the scope of the method, this integration time of the radiation detector is set depending on a speed of the aligning or deflecting of the beam or at least one of the beams, in particular dynamically.

24. A device for measuring depth information of a scene based on structured light generated by at least one parallel radiation source, wherein the device comprises:
at least one parallel radiation source, each for the generation of a respective electromagnetic beam;
at least one microscanner for time-dependent sequential aligning or optically imaging of the beam or at least one of the beams at different, in particular punctiform or line segment-shaped, locations of a three-dimensional scene in order to irradiate the scene using the at least one imaged beam in the form of an irradiation pattern resulting from the time-dependent alignment or imaging of the beam or beams and defined by one or more trajectories of the beam or beams;
a radiation detector for detecting at least in portions an image representation of the irradiation pattern generated by at least partial reflection of the irradiation pattern on one or more object surfaces in the scene, and for the generation of image information that represents the detected image representation of the irradiation pattern; and
an evaluation device for evaluating the image information in order to calculate therefrom depth information regarding the scene.

25. (canceled)

26. An electronic apparatus, comprising a device according to claim 24.

27. The method according to claim 4, wherein the beam or at least one of the beams is passed through a filter device for attenuating or filtering out electromagnetic radiation in a spectral range which is different from a wavelength or a wavelength spectrum of the beam, at least at one point along its path between the parallel radiation source and at least one radiation detector used to detect the image representation of the irradiation pattern.

28. The method according to claim 5, wherein in order to generate the irradiation pattern, the beam or at least one of the beams is guided through one or more optical elements of a diffractive or refractive type by means of which the respective beam is spread out.

29. The method according to claim 7, wherein the time-dependent sequential aligning or imaging of the beam or at least one of the beams at different locations of the three-dimensional scene takes place in a non-periodic manner, so that the trajectory of the respective beam runs non-periodically at least for certain periods of time.

30. The method according to claim 8, further comprising:
generating a position signal which represents, as a function of time, information which characterizes an orientation or imaging direction of the beam or at least one of the beams or a respective orientation or imaging direction present at the respective point in time.

31. The method according to claim 16, wherein the image information is evaluated using a trained artificial neural network.

32. The method according to claim 1, wherein at least one radiation detector is used to detect the image representation of the irradiation pattern, the integration time of which detector can be variably adjusted, wherein, within the scope of the method, this integration time of the radiation detector is set depending on a speed of the aligning or deflecting of the beam or at least one of the beams, in particular dynamically.
